(19) United States
(12) Patent Application Publication
(10) Pub. No.: US 2012/0232705 A1
(43) Pub. Date: Sep. 13, 2012

(54) METHODS AND APPARATUS FOR ENHANCED RECOVERY OF UNDERGROUND RESOURCES

(75) Inventor: RAYMOND S. HOBBS, Avondale, AZ (US)

(73) Assignee: Mesquite Energy Partners, LLC

(21) Appl. No.: 13/416,570

(22) Filed: Mar. 9, 2012

Related U.S. Application Data
(60) Provisional application No. 61/451,249, filed on Mar. 10, 2011.

(51) Int. Cl. G05D 7/00

(52) U.S. Cl. 700/282

(57) ABSTRACT

An enhanced system for recovering underground resources according to various aspects of the present invention is configured to increase and/or maintain a more constant output of a resource from an underground reservoir over time without damaging the reservoir. In one embodiment, the enhanced system for recovering underground resources comprises a monitoring system that continuously adjusts a formula for temperature and pressure controlled gases that are injected into the underground reservoir during a process of moving the resource to the surface for recovery. The monitoring system is adapted to utilize known and varying features and parameters of a given underground reservoir over time to maintain a more constant output from the reservoir.

### CROSS-REFERENCES TO RELATED APPLICATIONS

This application claims the benefit of U.S. Provisional Patent Application No. 61/451,249, filed Mar. 10, 2011, and incorporates the disclosure of the application by reference.

### BACKGROUND OF THE INVENTION

The typical conditions required to form reservoirs of underground resources varies. For example, a resource such as hydrocarbons require rock rich in hydrocarbon material at sufficient depth and heat to cook it; a porous rock for it to accumulate in; and a cap rock (seal) that prevents it from escaping to the surface. Hydrocarbon reservoirs typically very often have three-layers of fluid comprising a layer of water below a liquid hydrocarbon and a layer of gas above it. These layers may vary in size from one reservoir to another. Hydrocarbons commonly move upward through adjacent rock layers and may either eventually reach the surface or become confined in porous rock trapped beneath an impermeable rock layer, due at least in part to the lower density of the hydrocarbon as compared to rock and water. The migration process of the hydrocarbons may also be influenced by underground water flows, which allow the hydrocarbons to travel unique distances before being trapped in a final reservoir.

The recovery of hydrocarbons from underground reservoirs has progressed continuously since 1860 to its existing status as a major industry. The Oil and Gas industry has developed considerable geological petroleum science to understand underground petroleum bearing formations and created various technologies to economically recover oil and gas from beneath the surface of the earth.

In one example, an underground resource may be extracted from the earth by drilling into a reservoir and installing a recovery well. The recovery well facilitates the flow of the reservoir gas and/or liquid to the surface. Often the reservoir has sufficient natural pressure to force the underground resource to the surface when the reservoir is first “tapped.” Over time, this natural pressure dissipates and the underground resource must be brought to the surface by some additional process such as pumping. Eventually, the ability to continue recovering the underground resource by pumping diminishes, thereby resulting in low field production, which can lead to an abandoning of the reservoir and/or well when it is no longer economically viable to continue extracting the underground resource. Although it may not be economically worthwhile to continue extracting the underground resource using the primary methods discussed above, it is believed that that any given reservoir may still contain 70% to 80% of the original reservoir quantity.

Due to such a large remaining amount of the underground resource, additional/secondary processes have been developed to extract a greater percentage of the remaining resource. For example, low primary reservoir production can lead to a secondary production process such as water flooding. Water flooding operations comprise injecting water into the reservoir with the desired result being the successful extraction of additional oil or gas. This process may be also be limited as a result of water break through or when the ratio of well water to extracted oil reaches an unfavorable economic point.

Additional recovery methods have been developed in an attempt to improve the production out of a given reservoir. For example, these additional methods may include: steam injection (also called Huff and Puff), ambient temperature CO2 injection, liquid nitrogen injection, solvent injections, microbial recovery, and air injection (called Toe to Heel), which creates heat by combustion in the underground reservoir. However, a major drawback from many of these recovery methods is that they can permanently damage the reservoir and, as a result, leave the majority of the original resource in place and unrecoverable.

### SUMMARY OF THE INVENTION

An enhanced system for recovering, underground resources according to various aspects of the present invention is configured to increase and/or maintain a more constant output of a resource from an underground reservoir over time without damaging the reservoir. In one embodiment, the enhanced system for recovering underground resources comprises a monitoring system that continuously adjusts a formula for temperature and pressure controlled gases that are injected into the underground reservoir during a process of moving the resource to the surface for recovery. The monitoring system is adapted to utilize known and varying features and parameters of a given underground reservoir over time to maintain a more constant output from the reservoir.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a recovery system in accordance with an exemplary embodiment of the present invention;

FIG. 2 is a flowchart representing the recovery system in accordance with an exemplary embodiment of the present invention;

FIG. 3 representatively illustrates a gas processing system in accordance with an exemplary embodiment of the present invention;

FIG. 4 representatively illustrates a control system for the recovery system in accordance with an exemplary embodiment of the present invention; and

FIG. 5 representatively illustrates a hydrocarbon recovery system in accordance with an exemplary embodiment of the present invention.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various types of heavy equipment, oil wells, gas wells, drilling equipment, high pressure injection equipment, storage equipment for various types of hydrocarbons, noble gases, and the like, which may carry out a variety of functions. In addition, the present invention may be practiced in conjunction with any number of processes such as underground oil and/or gas recovery, power generation, and carbon emissions reduction, and the system described is merely one exemplary application for the invention. Further, the present invention may employ any number of conventional techniques for extracting materials located underground, modifying compositions of flowing gases, process monitoring, and/or converting fluids from one state to another.

Methods and apparatus for enhanced recovery of underground resources according to various aspects of the present invention may operate in conjunction with any suitable exploration and/or natural resource recovery process. Various representative implementations of the present invention may be applied to any system for pumping, pressurizing, and/or injecting materials into a well field, hydrocarbon reservoir, or gas reserve to aid in the extraction process.

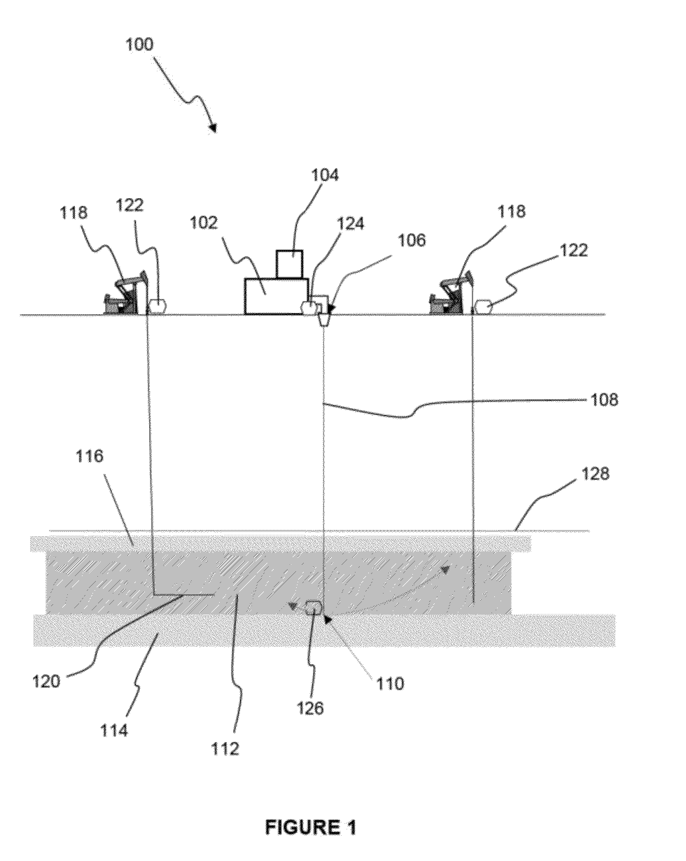

Referring now to FIG. 1, methods and apparatus for enhanced recovery of underground resources may comprise a recovery system 100 configured to inject a mass flow of injection gas 108 from a gas processing system 102 into an underground reservoir 112 to extract the underground resource with one or more recovery wells 118. A control system 104 may be linked to the gas processing system 102 and be suitably configured to control a composition of the injection gas 108. For example, in one embodiment the control system 104 may iteratively customize a formulation of temperature and pressure controlled gases for injection beneath an impermeable rock layer 128 into the underground reservoir 112 that may be positioned between a brine layer 114 and a gas layer 116 to improve, control, modify, or account for various properties and conditions of the underground resource or underground reservoir 112. Some properties include: crude oil viscosity, formation permeability, formation brine, size of formation clays and mud, create or improve or maintain the underground reservoir 112 natural drive characteristics, and change the underground reservoir 112 by an in-situ process capable of altering the physical characteristics of hydrocarbons present in the underground reservoir 112.

The gas processing system 102 is suitably configured to create the injection gas 108 and inject the injection gas 108 into an underground reservoir 112 through an injection point 106. The gas processing system 102 may comprise any suitable device or system to form the injection gas 108 for enhancing the ability to extract a desired resource from the underground reservoir 112. The gas processing system 102 may comprise any suitable components for processing gases and fluids such as pumps, compressors, condensers, dryers, tanks, and the like. For example, the gas processing system 102 may be configured to modify, alter, or otherwise change the composition, pressure, and/or temperature of an ambient airflow to a desired composition, pressure, and temperature that is suitable for a given resource recovery operation. In one embodiment for crude oil extraction, the injection gas 108 is generated according to a specific recipe of gases and additives and processed to a predetermined temperature and pressure value prior to being injected into the underground reservoir 112 with the goal of facilitating extraction of crude oil by altering the viscosity of the underground reservoir 112 without the use of water or steam.

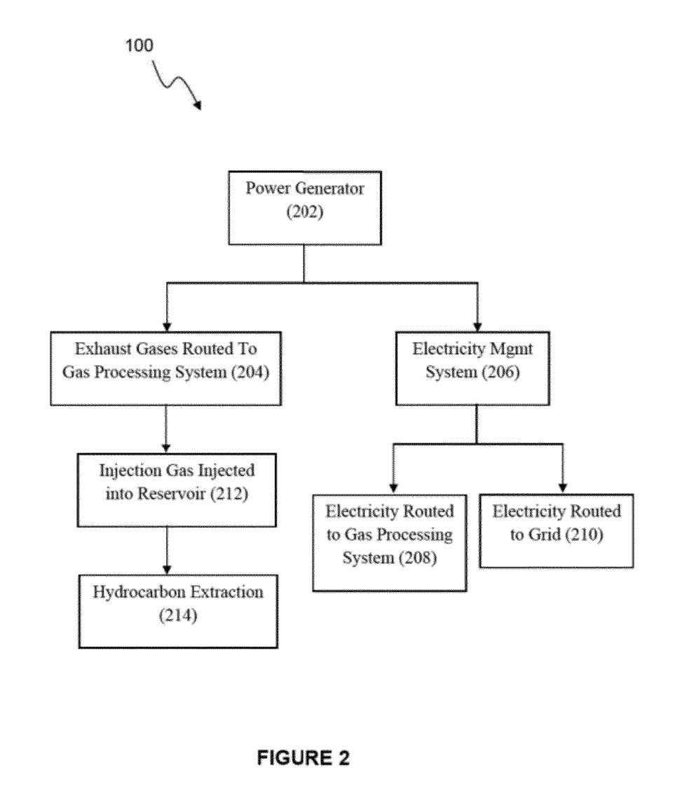

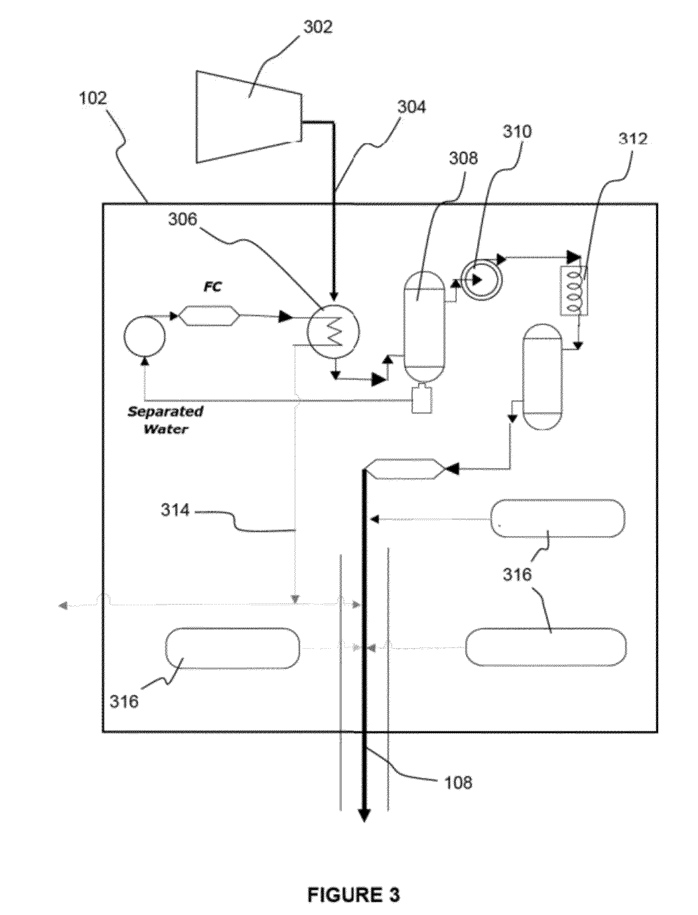

The ambient airflow may comprise any suitable source of airflow containing one or more gases. The airflow may be delivered to the gas processing system 102 from a remote location or it may be generated locally to the recovery operation. In one embodiment, the ambient airflow may comprise an exhaust gas from an internal combustion engine or gas turbine. For example, referring now to FIGS. 1, 2 and 3, the recovery system 100 may be configured to generate electricity such as with a gas turbine generator 302 (202). An electricity management system linked to the generator 302 may be used to route generated electricity to at least one of the gas processing system 102 (206), the one or more recovery wells 118, other recovery operation equipment, and an electrical power grid (208)(210). A mass flow of exhaust gas 304 from the generator 302 may be routed to the gas processing system 102 where it may be processed to form the injection gas 108 (204). The injection gas 108 may then be injected into a well field or underground reservoir 112 (212), to facilitate the extraction of hydrocarbons (214).

Exhaust gas 304 from the generator 302 may be processed by the gas processing system 102 to add or remove elements, compounds, or other constituent materials to form the injection gas 108. The exhaust gas 304 may be processed or treated by any suitable system or method to modify the composition, characteristic, or rate of the mass flow of the exhaust gas 304. In addition, the exhaust gas 304 may be suitably processed to adjust a pH level of the gases, such as to reduce the corrosiveness of the gases processed by the gas processing system 102. For example, hot exhaust gas 304 produced by the generator 302 may be cooled by a heat exchanger 306 to condense water vapor created during the combustion process. The condensed water vapor may then be separated from the exhaust gas by a condenser 308. Collected water may be further processed to remove or reduce contaminates, acidity, alkalinity, and the like. The resultant water product may then be used for any desired function. For example, in one embodiment, resultant water product may be processed into steam 314 and added to the injection gas 108. In a second embodiment, resultant water product may be used in a by-product operation such as for agricultural or aquacultural uses.

The amount of water vapor separated from the exhaust gas 304 may be controlled according to a predetermined control function created by the control system 104 based upon a number of factors, including but not limited to the underground reservoir 112 geology, a desired change to the reservoir parameters, the type of underground resource, recovery pressures, recovery temperatures, and the desired injection parameters. In one embodiment, one recovery operation may require that the injection gas 108 comprise less than 3% water vapor. In another embodiment a recovery operation may require the injection gas 108 comprise a water vapor level of less than 1%. In yet another embodiment, a recovery operation may require the residual water vapor level for the injection gas 108 comprise a range of acceptable water vapor values between 0.1% and 5%.

Once the flow of exhaust gas 304 has been condensed and the water vapor level has been reduced, the exhaust gas 304 may be at a lower temperature than when the exhaust gas 304 initially exited the generator 302. As a result, the gas processing system 102 may be configured to further increase the pressure and/or temperature of the injection gas 108 to a predetermined level. For example, an exhaust gas 304 having less than 1% moisture content may be directed towards a compressor 310 to increase the pressure and temperature of the exhaust gas 304 to a level set by the control system 104. The temperature of the exhaust gas 304 may be increased by any suitable method. For example, heat generated by subsystems within the gas processing system 102 may be used to increase the temperature of the exhaust gas 304.

The gas processing system 102 may also be configured to remove oxygen from the exhaust gas 304. For example, oxygen may be required by the generator 302 to perform necessary combustion reactions for power generation. However, as a result of imperfect combustion, the exhaust gas 304 may contain uncombusted oxygen at varying levels of concentration over time. The gas processing system 102 may be controlled by the control system 104 to limit the concentration of entrained oxygen in the exhaust gas 304 to reduce potential unintended reactions in the underground reservoir 112. For example, high pressure and/or temperature injection gas 108 that contains oxygen may react violently with other volatile gases in the underground reservoir 112 or the presence of oxygen in the injection gas 108 may result in other unwanted oxidation reactions. Similarly, the presence of both oxygen and hydrogen in high pressure and/or temperature injection gas 108 may result in undesired conditions or reactions. Accordingly, the gas processing system 102 may comprise any suitable device for removing oxygen from the mass flow of the exhaust gas 304, such as by using a catalytic reduction unit 312. For example, in one embodiment, oxygen concentration in the exhaust gas 304 can be reduced to less than 2% content by volume in the final injection gas 108.

The gas processing system 102 may also be configured to mix supplemental additives 316 such as carbon dioxide, hydrogen, steam, hydrocarbons, solvents, paraffin inhibitors, catalysts, and/or dispersants into the injection gas 108. The concentration of supplemental additives 316 and the final composition of injection gas 108 may be determined by the control system 104. For example, in one embodiment, recovery of high viscosity hydrocarbons from the underground reservoir 112 may require the addition of supplemental additives 316 to the injection gas 108 to enhance the effects of pressure and temperature for more efficient recovery. A supplemental additive 316 such as hydrogen may increase dispersion of the injection gas 108 through the reservoir and assist with production well modulation operation for effective underground reservoir 112 thermal gradients. Further, the use of additives 316 such as hydrogen over time may assist in in-situ carbon chain modification to aid recovery of the hydrocarbons. For example, through an in-situ cracking process, high viscosity hydrocarbons may be broken down into smaller hydrocarbons that may be more easily removed from the underground reservoir 112.

In one embodiment, the gas processing system may be configured to add carbon dioxide to the injection gas 108. Carbon dioxide miscibility may also provide additional assistance in creating or increasing a natural drive mechanism in the underground reservoir 112 to further enhance recovery efforts. The recovery system 100 may be further configured to capture and recycle carbon dioxide for use by the gas processing system 102. For example, the recovery system 100 may be configured to process carry-over in well product at the recovery wells 118 to collect carbon dioxide extracted from the underground reservoir 112 or from any other carbon dioxide producing process in the recovery system 100 and subsequently transfer any captured carbon dioxide to the gas processing system 102 for use as an additive 316 to the injection gas 108.

The recovery system 100 may also be configured to capture and recycle light hydrocarbons to assist with additional recovery. For example, natural gas recovered at the recovery wells 118 may be transferred to the gas processing system 102 where it may be added to the injection gas 108 as an additive 316 rather than burned off at individual recovery wells 118.

The gas processing system 102 may also be configured to generate an injection gas 108 that can reduce the impact of negative natural drive mechanisms in the underground reservoir 112. For example, paraffins are commonly found in the alkanes component of hydrocarbon reservoirs. Paraffin can create blockages in the underground reservoir 112 and in the recovery wells 118. Accordingly, the gas processing system 102 may be configured to use an additive 316 such as a paraffin inhibitor to the injection gas 108 to facilitate the effectiveness of the injection gas 108 in reservoirs where paraffins are found.

The gas processing system 102 may also be adapted to inject the injection gas 108 into the underground reservoir 112 by any suitable method. For example, the gas processing system 102 may comprise a direct reservoir injection system with individual non-mixture injection gas 108 or in combination in a continuous, sequenced, or pulsed reservoir release regiment. In another embodiment, the gas processing system 102 may comprise a horizontal injection system 120 suitably adapted to inject the injection gas 108 at one or more points distant from a location of the surface injection point 106.

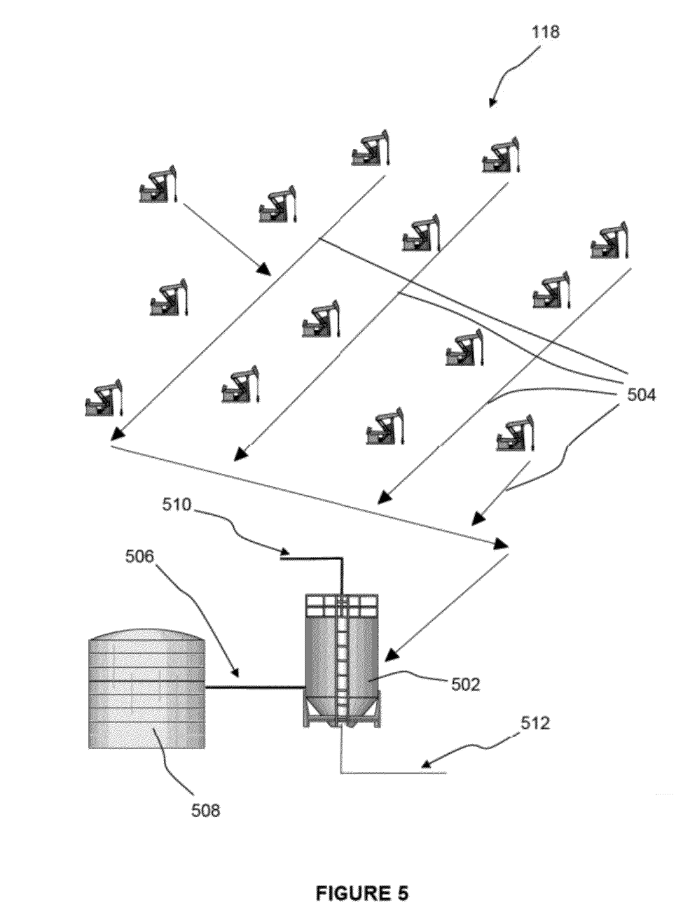

The recovery wells 118 may comprise any suitable method or system for capturing the released resource as a result of the injection gas 108 being introduced into the underground reservoir 112. For example, referring to FIGS. 1 and 5, recovery wells 118 may comprise one or more oil wells forming individual variable flow channels 504. The recovery wells 118 may be linked to a separator 502 adapted to create individual streams of output for the various constituent components of the resource. For example, in one embodiment, a separator 502 may be configured to separate recovered hydrocarbons into a vapor flow 510 of gaseous compounds that may be used by the gas processing system 102, a flow of water 508 that may be used by the recovery system 100, and a flow of crude oil 506 that is sent to a storage tank 508.

The recovery system 100 may also be suitably configured to reduce and/or eliminate emitted carbon dioxide emissions. For example, wastes from petroleum recovery operations such as carbon dioxide emissions from the power generator 302 may be captured and used by the gas processing system 102 to form at least a part of the injection gas 108 and deposited in the underground reservoir 112 rather than be released into the atmosphere. The recovery system 100 may also be configured to save or recycle inert gases released during the extraction process.

Additionally, individual components separated by the separator 502 may be further processed by any suitable method or system according to a desired need. For example, water 508 may be treated by processes such as filtration, centrifuge separation, and dense phase separation to allow for subsequent use of the water 508. Product water from processing steps may then be supplied to a recovered water system for use by the gas processing system 102 including steam production for possible use in the injection gas 108. In another embodiment, the recovery system 100 system may combine recovered brine water 508 from the reservoir with an algae farm to create bio fuel or other similar use.

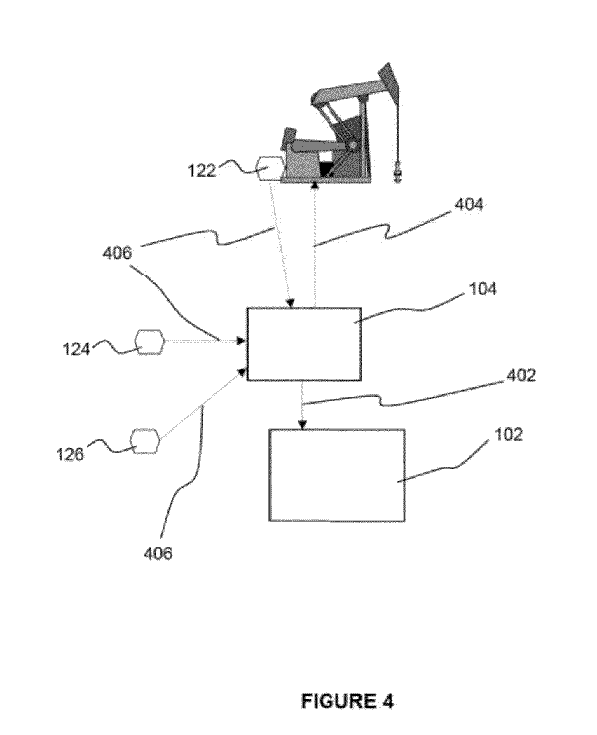

Referring now to FIGS. 1 and 4, the control system 104 may analyze various input signals and create a control signal 402 that is provided to the gas processing system 102 comprising instructions for formulating the composition of the injection gas 108. The control system 104 may comprise any suitable system or method for processing input signals to generate a suitable injection gas 108. The control system 104 may also be adapted to provide a second control signal 404 to the recovery wells 118 such that mass flow rates out of the underground reservoir 112 may be actively controlled. The control system 104 may also be adapted to receive real-time data 406 collected from one or more sensors to create an injection gas 108 formulation that varies over time based upon a desired output from the underground reservoir 112 and the collected real-time data 406.

Real-time data 406 may comprise any suitable variable for analyzing the injection gas parameters, conditions within the reservoir, extraction rate, and the product recovered at the recovery wells 118. Real-time data 406 may be collected at various stages of the recovery process to determine the presence or level of factors such as water, paraffins, methane, naphtalenes, asphaltenes, carbon dioxide, and aromatics. Additionally, one or more of the variable flow channels 504 may be analyzed for viscosity, composition, pressure, temperature and/or flow-rate which may be used by the control system 104 to adjust the composition of the injection gas 108.

For example, conditions in the underground reservoir 112 will change over time with the cumulative effect and volume of the injection gas 108 injected into the underground reservoir 112. In response to these changing conditions, the control system 104 may continuously adjust the composition of the injection gas 108 to maintain a desired output of the extracted resource. For example, the control system 104 may determine that the initial injection gas 108 may comprise less than 2% oxygen, less than 1% water vapor, have a pressure of at least 150 psia, and be at least 300 degrees Fahrenheit when injected at the injection point 106. Over time, and as real-time data 406 is collected, the control system 104 may signal the gas processing system 102 to adjust the temperature and pressure of the injection gas 108 based upon the physical conditions of the underground reservoir 112 and analysis of well product at the recovery wells 118.

The sensors may be located at various locations throughout the recovery system 100. For example, an injection sensor 124 may be positioned at the injection point 106 and be configured to monitor various parameters such as temperature, pressure, and flow rate of the injection gas 108 where it first enters the injection point 106. A reservoir sensor 126 may be located at a reservoir entry point 110 where the injection gas enters the reservoir and be configured to monitor various parameters such as temperature, pressure, and flow rate of the injection gas 108. A recovery sensor 122 may be located at a recovery well 118 and be adapted to monitor parameters including, but not limited to: the pressure and flow rate of extracted hydrocarbons or other recovery well product; viscosity; temperature of recovered product; ratios of constituent parts of the recovered product such as water, gas, and hydrocarbon; and the composition of any recovered gas.

The control system 104 may be adapted to adjust the injection gas 108 physical characteristics based real-time data 406 collected from the sensors 122, 124, 126. Further, data from sensors may be iteratively incorporated into the control system 104 to modify variables relating to the composition of the injection gas 108. For example, the injection gas 108 temperature, pressure, composition, and flow rate may be determined by an algorithm developed for the underground reservoir 112 based upon the temperature and/or pressure differentials between the injection point 106 and the reservoir entry point 110, hydrocarbon characteristics, production rates, geology, permeability, porosity, brine content and composition, and changes within the underground reservoir 112 during recovery operations.

The control system 104 may create a unique control algorithm for each gas processing system 102 based upon a specific underground reservoir 112. In one embodiment, the geology of the underground reservoir 112 may be classified for use by the control system 104 to create an initial control signal 402 for use by the gas processing system 102 during the beginning stages of a recovery operation. The underlying geology of the underground reservoir 112 may be a factor in defining the initial control signal 402 for generating an initial injection gas 108 composition, pressure, and temperature. The control system 104 may also be adapted to account for factors such as existing knowledge that a sandstone formation may not be as reactive as a carbonate formation to given injection gas 108 composition.

For example, carbonate formations may react more favorably with hydrogen ions to produce carbon dioxide and water than a sandstone formation. Carbonates are anionic complexes of (CO₃)²⁻ and divalent metallic cations (Calcium, Magnesium, Iron, Manganese, Zinc, Barium, Strontium, Copper). Common hydrocarbon carbonate reservoirs comprise calcium carbonate (CaCO₃) and dolomite (Ca, Mg(CO₃)₂). The amount of water or brine in the formation, and its composition (salinity) may assist the control system 104 to define an appropriate composition for the injection gas 108. Carbon dioxide and oxides of nitrogen may create an acidity within the brine that may assist in changing the porosity of the formation resulting in the release of additional carbon dioxide. Further, the extent of any layering in the reservoir with clays and mud may also assist in determining augmentation of gas injection with channels.

Analyzing data from the recovery well sensors 122 by the control system 104 may also create an iterative process of adjusting the control algorithm to improve resource recovery. For example, recovery sensor 122 data may comprise well product temperature, chemical analysis, mass-flow, and gas analysis during the recovery operation. The control system 104 may use this information to adjust various elements of the injection gas 108 such as the concentration of the supplemental additives, pressure of the injection gas 108, and temperature of the injection gas 108.

In one embodiment, the control system may formulate the composition, temperature, and pressure of a desired injection gas 108 based upon variable such as reservoir displacement, reservoir pressure, hydrocarbon coking temperature, viscosity, thermal losses, pressure differentials and losses, mass flow rates through the gas processing system and reservoir. For example, the control system 104 may create a control algorithm to direct the gas processing system 102 to adjust a desired temperature and pressure level of the injection gas 108 to maintain a desired output at the recovery wells 118. The control algorithm may direct the gas processing system 102 to generate an injection gas 108 that is initially higher in at least one of pressure and temperature to account for losses between the injection point 106 and the reservoir entry point 110.

The iterative nature of the control system's 104 analysis of real-time data 406 may also allow for the development of a mass loss factor to assist with reservoir recovery planning. The control system 104 may utilize a mass-balance function which iterates a mass balance between the injection gas 108 delivered into the underground reservoir 112 with the mass of recovery well 118 production and reservoir 112 pressure changes. For example, analysis of well product to alter the composition of the injection gas 108 creates an iterative process of adjusting the control algorithm to improve hydrocarbon recovery by adjusting the concentration of the supplemental additives 316 added to the injection gas 108. Well product temperature, chemical analysis, mass-flow, and gas analysis may provide data for the adjustments to the control system 104.

In operation, an initial data set comprising information specific to a given underground reservoir 112 may be supplied to the control system 104. The information may comprise known geological properties of the underground reservoir 112, such as formation type, known pressure or temperatures levels within the underground reservoir, the type of underground resource located in the underground reservoir 112, depth below ground, or any similar data. The control system 104 may analyze the initial data set to create an initial control algorithm that may be sent to the gas processing system 102 in the form of a control signal 402.

The gas processing system 102 may use the control signal 402 to form an initial injection gas 108. The control may contain instructions that will control how the gas processing system generates the injection gas 108. For example, a control signal 402 based on the initial data set, may comprise instructions directing the gas processing system 102 to form an injection gas 108 that comprises less than 2% oxygen, less than 1% water vapor, have a pressure of between 150-180 psia, and between 300-325 degrees Fahrenheit.

The gas processing system 102 may generate the injection gas 108 with the desired composition and properties through any suitable means. For example, the gas processing system 102 may process an incoming mass flow volume of exhaust gas 304 from a generator 302 with any suitable devices or systems to modify the exhaust gas 304 into an injection gas 108 that meets the criteria established by the control system 104. Once the injection gas 108 is formed, the gas processing system 102 may then inject the injection gas 108 into the underground reservoir 112. Alternatively, the gas processing system 102 may route the injection gas 108 to an injection system that is suitably configured to injection the injection gas 108 into the underground reservoir 112.

The injection gas 108 may be injected into the underground reservoir 112 through any suitable method or system. For example, in one embodiment, the gas processing system 102 may comprise a direct reservoir injection system that is suitably configured to inject the injection gas 108 in a continuous flow according the control signal 402.

Sensors may be positioned throughout recovery system 100 and be configured to capture real-time data 406 relating to the injection gas 108, changes in the underground reservoir 112, and extraction flows at one or more recovery wells 118. For example, an injection sensor 124 may be located at the injection point 106 and be suitably configured to monitor the composition and properties of the injection gas 108. The injection sensor 124 may be communicatively linked to the control system 104 and be adapted to communicate the real-time data 406 collected by the injection sensor 124 to the control system 104 for processing.

A reservoir sensor 126 may be located at the point where the injection gas 108 enters the underground reservoir 112 and be suitably configured to monitor the composition and properties of the injection gas 108 in addition to any changing parameters or properties of the underground reservoir 112 including but not limited to pressure and temperature changes and changes in porosity of the formation. Additional sensors may be located at other locations such at locations where the underground resource is extracted. Recovery sensors 122 may be located at one or more recovery wells 118 and be configured to monitor parameters including but not limited to mass flow extraction rates at the recovery well, viscosity, temperature, pressure, and composition of the material extracted at the recovery well 118.

The reservoir sensor 126 and the recovery well sensor 122 may also be communicatively linked to the control system 104 and be adapted to communicate the real-time data 406 collected at each sensor to the control system 104. The control system 104 may process the received real-time data 406 to create an updated control algorithm and control signal 402. The control system 104 may analyze the real-time data 406 through by any appropriate process such as continuously, intermittently, at predetermined intervals, or on command of an operator.

As a result of the analysis of the real-time data 406, the control system 104 may generate a new control algorithm based upon any suitable criteria. For example, the control system 104 may generate an updated control algorithm to account for factor including but not limited to: system losses, changes in the parameters of the underground reservoir 112, changes in extraction flow rates, changes in composition of extracted materials at the recovery wells 118, updated geological information, differences between parameters such as temperature and/or pressure at individual recovery wells 118, temperature gradients within the underground reservoir 112, and blockages.

For example, after analyzing the real-time data 406, the control system 104 may generate an updated control algorithm and control signal 402 based on the initial data set, may comprise instructions directing the gas processing system 102 to modify the injection gas 108 from its original parameters to one that comprises less than 2% oxygen, less than 1% water vapor, has a pressure of between 195-215 psia, and between 325-345 degrees Fahrenheit. Over time, the control system 104 may generate yet another updated control signal 402 containing instructions to further alter the existing parameters of the injection gas 108 such as to change pressure of the injection gas 108, change the temperature of the injection gas 108, and to include one or more supplemental additives 316 into the composition of the injection gas 108.

The real-time data 406 may also be used by the control system 104 to generate a second control signal 404 that may be provided to the recovery wells 118. For example, the real-time data 406 may indicate that one recovery well 118 is extracting the underground resource at a higher rate than a second recovery well 118. Upon analysis, the control system 104 may attempt to equalize extraction rates at each recovery well 118 by sending the second control signal 404 to the first recovery well 118 with an instruction for the first recovery well 118 to reduce the mass flow extraction rate. In another embodiment, the real-time data 406 may indicate that product extracted at one recovery well 118 is at a higher temperature then product extracted from the second recovery well 118. This difference may indicate that the temperature of the underground reservoir 112 is not uniform across the entire well field. In response, the control system 104 may attempt to reduce the temperature gradient within the underground reservoir 112 by generating one or more additional control signals that direct the gas processing system 102 and/or the recovery wells 118 to alter their performance.

The invention has been described with reference to specific exemplary embodiments. Various modifications and changes, however, may be made without departing from the scope of the present invention. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to a preferred embodiment. However, changes and modifications may be made to the preferred embodiment without departing from the scope of the present invention. These and other changes or modifications are intended to be included within the scope of the present invention, as expressed in the following claims.

1. An enhanced hydrocarbon recovery system for an underground hydrocarbon reservoir having an injection point and a recovery well, comprising:
a gas processing system configured to:
receive an initial gas flow;
modify the initial gas flow to form an injection gas according to a control signal; and
inject the injection gas into the underground hydrocarbon reservoir through the injection point; and
a control system linked to the gas processing system, the injection point, the reservoir, and the recovery well, wherein the control system is configured to:
generate a real-time input data set from the injection gas and recovered hydrocarbons;
create the control signal by processing the real-time input data with a control algorithm configured to produce a desired output from the recovery well, wherein the control signal comprises instructions for:
modifying the composition of the initial gas flow to alter the formed injection gas;
controlling a mass flow rate of the injection gas; and
controlling the temperature and pressure of the mass flow rate of the injection gas that is injected at the injection point; and
provide the control signal to the gas processing system.

2. An enhanced hydrocarbon recovery system according to claim 1, wherein the control system is further configured to:
generate a second control signal for controlling the recovery well; and
dynamically adjust the first control signal instructions according to the real-time data.

3. An enhanced hydrocarbon recovery system according to claim 1, further comprising an electric generator configured to produce the initial gas flow from a flow of exhaust gas exiting the electric generator.

4. An enhanced hydrocarbon recovery system according to claim 1, wherein an initial control signal is determined based on a geological analysis of the reservoir prior to beginning a hydrocarbon recovery process.

5. An enhanced hydrocarbon recovery system according to claim 1, wherein the gas processing system is configured to modify the composition of the initial gas flow to reduce a water vapor level of the initial gas flow to less than about three percent of the total mass flow.

6. An enhanced hydrocarbon recovery system according to claim 1, wherein the gas processing system is configured to modify the composition of the initial gas flow to reduce an oxygen level of the initial gas flow to less than about four percent of the total mass flow.

7. An enhanced hydrocarbon recovery system according to claim 1, wherein the real-time input data set comprises:
a pressure differential between the injection gas at the injection point and the injection gas as it enters the reservoir;
a temperature differential between the injection gas at the injection point and the injection gas as it enters the reservoir;
a reservoir pressure;
a reservoir temperature; and
a hydrocarbon output at the recovery well.

8. An enhanced hydrocarbon recovery system according to claim 7, wherein the control system is further configured to modify input data set to further comprise variables based on an analysis of recovery well product for at least one of viscosity, composition, temperature, hydrocarbon to water ratio, and composition recovered gas.

9. An enhanced hydrocarbon recovery system according to claim 8, wherein the control system is further adapted to provide instructions in the control signal for causing the gas processing system to modify the composition of the injection gas by including a predetermined concentration of an additive to the initial gas flow.

10. An enhanced hydrocarbon recovery system according to claim 9, wherein the additive comprises at least one of hydrogen, recycled carbon dioxide from the recovery well, recycled hydrocarbons from the recovery well, a catalyst, and a paraffin inhibitor.

11. A method of enhanced hydrocarbon recovery from an underground reservoir comprising:
generating an initial composition of injection gas with a gas processing system by modifying an exhaust gas flow from an electric generator, wherein the initial composition of injection gas is based upon a geologic analysis of the reservoir;
injecting the initial composition of injection gas into the reservoir with the gas processing system at an injection point;
monitoring a temperature and pressure value for the injection gas at:
the injection point; and
at an entry into the underground reservoir;
analyzing the monitored temperature and pressure values with a control algorithm to form a control signal comprising instructions for:
modifying a composition of the exhaust gas flow;
controlling a mass flow rate of the injection gas; and
controlling the temperature and pressure of the mass flow rate of the injection gas
communicating the control signal to the gas processing system, wherein the control signal is used by the gas processing system to generate a second composition of injection gas; and
injecting the second composition of injection gas into the reservoir at the injection point.

12. A method of according to claim 11, further comprising monitoring a temperature and pressure value for:
the reservoir; and
recovered hydrocarbons at a recovery well,
wherein the monitored values are analyzed by the control algorithm to further form the control signal.

13. A method of according to claim 12, further comprising:
monitoring the hydrocarbons recovered at the recovery well for viscosity; and
analyzing the monitored viscosity for the hydrocarbons with the control algorithm to further form the control signal.

14. A method of according to claim 13, wherein the control signal further comprises variables based on an analysis of the recovered hydrocarbons at the recovery well for at least one of composition, hydrocarbon to water ratio, and composition recovered gas.

15. A method of according to claim 11, further comprising reducing a water vapor level of the exhaust gas flow to less than about three percent of the total mass flow.

16. A method of according to claim 11, further comprising reducing an oxygen level of the exhaust gas flow to less than about four percent of the total mass flow.

17. A method of according to claim 11, further comprising including a predetermined concentration of an additive to the exhaust gas flow in accordance with the control signal.

18. A method of according to claim 17, wherein the additive comprises at least one of hydrogen, recycled carbon dioxide from the recovery well, recycled hydrocarbons from the recovery well, a catalyst, and a paraffin inhibitor.
